(19) United States
(12) Patent Application Publication
(10) Pub. No.: US 2009/0055511 A1
(43) Pub. Date: Feb. 26, 2009

(54) NON-PROGRAMMATIC ACCESS TO DATA AND TO DATA TRANSFER FUNCTIONS

(75) Inventors: Robert Francis Berry, Durley (GB); Gareth Edward Jones, Winchester (GB); Saket Rungta, Jaipur (IN); Christopher Edward Sharp, Winchester (GB)

Correspondence Address: IBM Corporation-Raleigh SWG;c/o Thomas & Raring, P.C, 536 Granite Avenue, Richmond, VA, 23226, US

(73) Assignee: International Business Machines Corporation, Armonk, NY (US)

(21) Appl. No.: 12/132,149

(22) Filed: Jun. 3, 2008

(30) Foreign Application Priority Data
Aug. 20, 2007 (EP) 07114589.0

(51) Int. Cl. G06F 15/16

(52) U.S. Cl. 709/218

(57) ABSTRACT

Provided are methods, apparatus and computer programs for generating messages, for transferring data between data processing system entities such as between application programs running on data processing systems within a network, and for providing file-oriented data processing system entities with access to data and access to messaging functions. A first method generates messages for transfer within a messaging network, by creating files within one or more monitored file system directories, and using a monitoring component to identify newly created files within the monitored directories. The method involves extracting the file contents and generating a message that includes the extracted file contents, and then passing the message to a messaging manager.

### CROSS-REFERENCE TO RELATED APPLICATIONS

This application claims priority to United Kingdom Patent Application No. 07114589.0, filed Aug. 20, 2007, the contents of which are incorporated herein by reference in its entirety.

### FIELD OF INVENTION

Aspects of the present invention relate to transferring data between data processing system entities, such as between application programs running on data processing systems within a network, and providing file-oriented data processing system entities with access to data and access to messaging functions.

### BACKGROUND

Messaging middleware products have evolved to the point that they can provide excellent message delivery reliability and performance while shielding application program developers and users from the complexity of route determination, message delivery and format transformations that are required when transferring a message across a distributed heterogeneous data processing network. Typical enterprise messaging products allow application programs to access the messaging functions via a feature-rich Application Programming Interface (API). Such APIs can give application program developers, and potentially users of the application programs, a great deal of control over their messaging (e.g. defining persistence and priority attributes) without requiring each application developer to write a lot of complex code. Instead, application program developers can focus their attention on writing program code to implement desired application-specific and business-specific tasks, while relying on common functions provided by the messaging middleware.

Commercially-available messaging middleware products include, for example, the WebSphere MQ family of messaging middleware products from IBM Corporation, which use asynchronous messaging via queues (intermediate storage locations that avoid the need for sender and receiver applications to be active and accessible at the same time). A sender application program issues a ‘Put Message’ command (an API call) to send a message to a target queue, and the WebSphere MQ messaging middleware programs handle the complexities of transferring the message under transactional control from the sender to the target queue, which may be remotely located across a heterogeneous computer network. Having ‘Put’ the message, the sender application program can continue with other processing as it is not required to participate any further in the message communication. The messaging middleware programs implement transactional assured message delivery even when the destination application is not available at the time the message was sent (unlike the conversational, synchronous Remote Procedure Call communication model). The target queue is an input queue for another application program, which retrieves the message from this input queue by issuing a ‘Get Message’ command (another API call) asynchronously from the send operation. The receiver application program then performs its processing on the message, and may generate further messages. WebSphere and IBM are trademarks of International Business Machines Corporation.

IBM Corporation's WebSphere MQ products and messaging and queuing are described in a large number of publications that are available from IBM. In the early 1990s, IBM Corporation's messaging middleware products first implemented an API referred to as the Message Queuing Interface (MQI), as described by B. Blakeley, H. Harris and J. R. T Lewis in “Messaging & Queuing Using the MQI: Concepts and Analysis, Design and Development”, 1995, McGraw-Hill, Inc., New York, USA. More recently, additional APIs have been supported by various messaging products, including the Java™ Message Service (JMS) which is supported by many middleware vendors. Java is a trademark of Sun Microsystems, Inc.

Although messaging middleware with a well-designed API is a huge help to application program developers, greatly reducing the complexity (and therefore the development time) of many application programs, there is still a need for considerable domain-specific knowledge and skills before these traditional APIs can be used. A novice application program developer may have to invest a lot of time learning the details of an API before they can develop application programs that exploit the capabilities of the messaging middleware.

### SUMMARY

A first aspect of the present invention provides a method for generating messages for transfer within a messaging network (for example, for transfer between application programs and/or between data processing systems). The method involves responding to new files created within one or more monitored data storage areas within a file system (for example, within a particular monitored file system directory), using a monitoring component to identify newly created and modified files within the monitored storage areas. The method involves extracting the file contents and generating a message that includes the extracted file contents, and passing the message to a messaging manager. The steps of extracting, generating and passing may be performed by the monitoring component or by an additional component that is invoked by the monitoring component. The messaging manager provides messaging functions for delivering the message to its destination, which may be a target message queue of a messaging manager component running on a remote data processing system.

In a first embodiment of the invention, an originator application program can simply create or modify a file in a particular directory within a file system; leaving other system components to handle generation of a message that includes the contents of that file, and to handle transfer of the message across a network. A message is generated which includes the data contents of the created or modified file, but the data-containing structure of the original file is not a required part of the message—unlike some file transfer mechanisms. By extracting the file contents (instead of using a conventional file transfer mechanism in which messaging middleware requires the original file name, data structure and file organization and is unable to work with file contents), ‘mediations’ such as message modifications, format transformations, routing and filtering can be implemented more easily than with conventional file transfer mechanisms. Properties such as message expiry, priority and persistence can also be implemented within this first embodiment, and file names and attributes can be used in a novel way to specify desired messaging behavior (as described in the Detailed Description below).

The target of the message may be a message-oriented entity or a file-oriented entity within a data processing system; and in the latter case the message can be transformed into a file at the receiver system to facilitate access by a file-oriented target application.

According to this first embodiment, in order to send a message, the originator application program is not required to issue a ‘Put Message’ API call or any equivalent API call. The originator is also not required to explicitly specify a target destination, attributes of the message, or message communication characteristics. Instead, the directory in which the file is created or modified has a defined association with one or more destinations for the message, and a monitoring component identifies changes to this directory and interprets the presence of a new or modified file as an implicit instruction to send the file via an underlying message transfer mechanism. In this way, the creation or modification of a file in a particular directory implies the intention to send the file to a particular destination or to a plurality of destinations. This can be implemented to provide publish/subscribe messaging as well as point-to-point messaging.

In some cases, a message may target a queue on the same data processing system as the file-creator process, in which case this queue will be served by a process running on the same system, but the main benefits of messaging middleware are achieved when transferring message data across a network.

In a second aspect of the invention, within a message-receiving data processing system, a file creator component receives at least one message via a receiver messaging manager and creates or modifies at least one file to hold the contents of the received messages. The file creator component interprets a received message, extracts the message contents, creates or modifies at least one file to include the contents of the message, and saves the created or modified files within a particular target directory on the receiving system. Application programs running on this receiver system can then open the saved files when ready to perform their processing—working with simple file system operations without having to implement a complex messaging API.

The first and second aspects of the invention can be implemented as an alternative mechanism for accessing enterprise messaging functions, which is simpler for novice application developers than having to learn a complex API, and yet which can be implemented so as to support an equivalent level of flexibility to current feature-rich APIs. Aspects of the invention can be implemented at only the sender end of a communication path, only the receiver end, or both ends. The invention complements the asynchronous communication model that is implemented by many messaging middleware products, and exploits the efficient messaging functions provided by such products, but makes those functions more accessible to application programmers and users who lack knowledge of messaging APIs.

A third aspect of the invention provides a distributed messaging system comprising a sender data processing system and a receiver data processing system, wherein the sender and receiver systems each comprise at least one processing unit, at least one data storage unit and a messaging manager for handling delivery of messages between the sender and receiver systems; wherein the sender system comprises a monitoring component adapted to identify newly created and modified files within a monitored data storage area, to extract file contents from the identified files, to generate at least one message that includes the extracted file contents, and to pass the generated messages to the sender system's messaging manager; and wherein the receiver system comprises a file creator component adapted to receive at least one message via the receiver system's messaging manager, to extract the contents of the received messages, to create or modify at least one target file containing the contents of the received messages, and to save the created or modified target files within the receiver system.

Using such a distributed messaging system, file-oriented application programs running at the sender and receiver systems can communicate via message-oriented middleware and can benefit from the capabilities of the message-oriented middleware to work with the contents of a message (e.g. filtering messages or transforming the contents of a message that was generated at the sender system), instead of being limited to delivering the file in its original form.

### BRIEF DESCRIPTION OF DRAWINGS

Embodiments of the invention are described below in more detail, by way of example, with reference to the accompanying drawings in which:

FIG. 1 is a schematic representation of a set of components and data processing systems within a distributed data processing network, according to an embodiment of the invention;

FIG. 2 shows a sequence of operations performed at a sender data processing system according to an embodiment of the invention; and

FIG. 3 shows a sequence of operations performed at a receiver data processing system according to an embodiment of the invention.

### DETAILED DESCRIPTION OF EMBODIMENTS

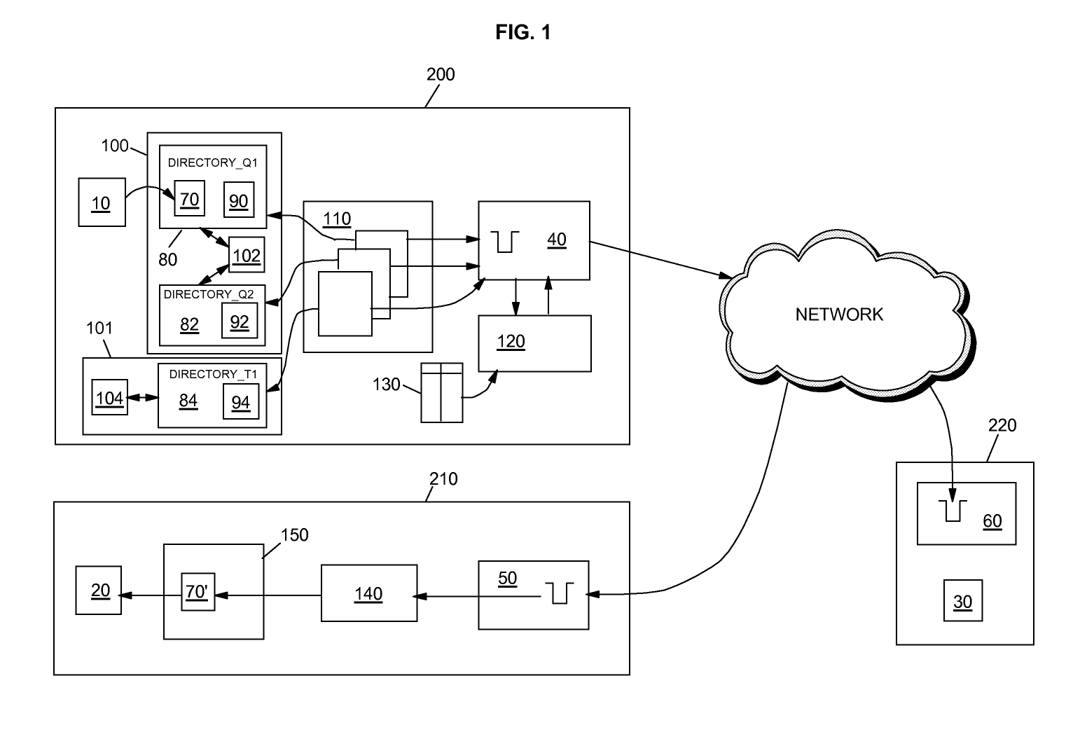

FIG. 1 shows part of a data processing network in which the present invention is implemented. In this first embodiment, the invention has been implemented to provide support for a first application program 10 at a sender data processing apparatus 200 and for a second application program 20 at a first receiver data processing apparatus 210, which may be remote from the sender data processing apparatus. The second application program 20 and a third application program 30 (which is running at a second receiver data processing apparatus 220) obtain access to data in response to actions initiated by the first application program 10.

The designation of “sender” and “receiver” herein is merely to facilitate a clear description of a particular sequence of operations, and is not intended to imply that the sender and receiver apparatus necessarily differ from each other or that they have limited roles within the network. A “sender” system may be a “receiver” system and vice versa. As is known in the art, messaging networks may comprise homogeneous or heterogeneous collections of data processing apparatus, potentially each running different operating systems and one or several application programs. Each data processing apparatus may run a messaging manager 40,50,60 which is capable of performing both sender and receiver functions. Some messaging networks include highly scalable and high-availability messaging manager servers running at some network nodes, with other nodes running small footprint client messaging programs that require the services of a messaging manager server running on a neighboring node of the network. Increasingly, as storage capacity and processing power becomes cheaper and more widely available, messaging functions may be implemented on any data processing device such as a mobile telephone, PDA, laptop or desktop computer as well as mainframe computers. The present invention is not limited to any specific types of data processing apparatus or messaging network topology. In a messaging network, there may be many different application programs that each interface with a particular one of a potentially large number of messaging managers, so the decision to show only three systems in FIG. 1 is for simplicity and for illustrative purposes only. The term ‘application program’ as used herein is not limited to any particular programming language or model, and is intended to encompass message-consuming entities such as, for example, message driven beans (MDBs) or applications written in Java™ or in a C-based language.

In this first embodiment, the messaging managers 40,50,60 are conventional message-oriented middleware (MOM) products such as the WebSphere MQ messaging manager products from IBM Corporation. Such products shield application programs from a great deal of the complexity inherent in network communications, by implementing functions within the messaging manager products for route determination and transactionally-assured message delivery across a heterogeneous network for both persistent and non-persistent messages, and by providing one or more APIs that enable application programs to invoke the messaging functions via API calls. Despite the great advantages of reliability and application programming efficiency that such products provide, developing programs that implement an API nevertheless requires considerable domain-specific knowledge that novice programmers may not have. Furthermore, there are a great many existing application programs that were written without messaging middleware in mind, and it can be difficult to justify the work involved in rewriting them to implement an API even when they could benefit significantly from use of messaging middleware.

The present invention avoids the need to learn the complexity of the messaging middleware product's APIs, and avoids the need to rewrite existing file-oriented application programs. Furthermore, the invention can provide support to file-oriented application programs written in any one of a number of different programming languages.

The present invention works with files within an operating system's file system. The files are each named (or otherwise identifiable) entities that contain some data and which are available to the data processing system's operating system. The structure of a file, the type of information represented by a particular sequence of binary digits within a file, and other characteristics such as data size limits, may vary between files and file types.

A file system typically comprises an organized set of files and a set of methods for organized storing, accessing and manipulating the files. A file system may have an associated data storage device which stores the physical files, or a file system may be ‘virtual’ and comprise a logical organization of files that are distributed across multiple storage devices. As is known in the art, typical file-oriented programs implement the following operations (although this varies for different operating systems and file systems):
Create a file;
Set attributes that control operations on the file;
Open a file to work with the file contents;
Read the file contents;
Update the file contents; and
Close the file.

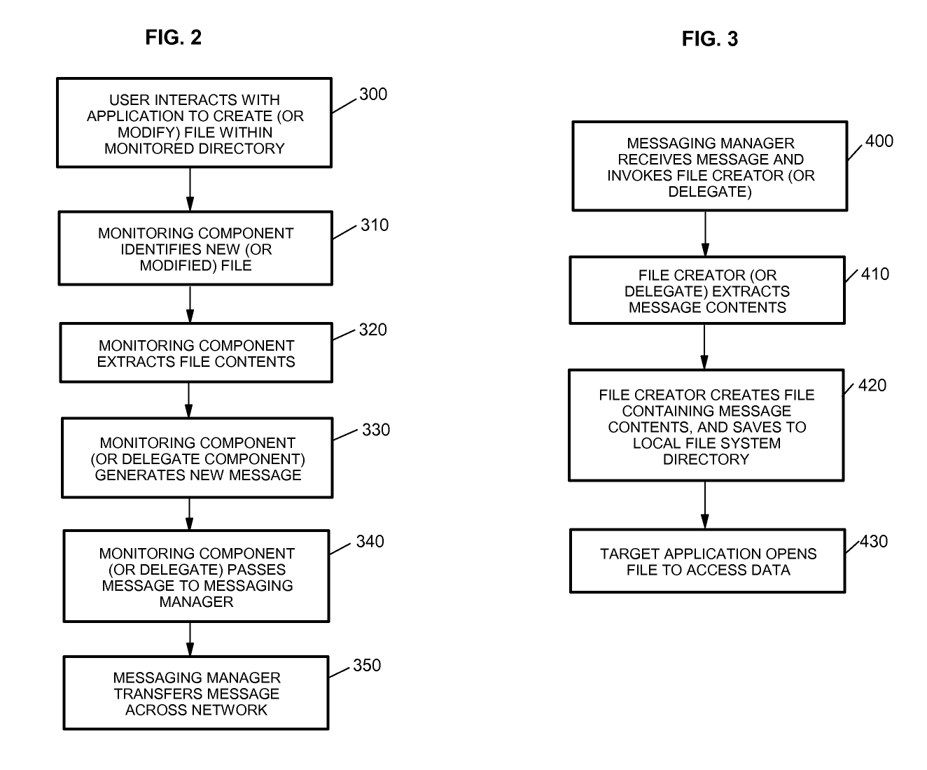

The present invention provides file-oriented application programs with access to messaging functions using conventional file system operations such as these. As shown in FIGS. 1 and 2, a first application program 10 initiates processing by creating 300 a file 70 within a file system directory 80 on its local data processing apparatus 200. The application program 10 is configured to store its created files under a given name within a specific named directory 80 within local data storage (for example within persistent disk storage of the data processing apparatus 200). The directory 80 is associated with a configuration file 102 that defines the properties of an associated communications channel, and files created within that directory are to be transmitted via the associated communications channel using the defined channel properties. The first application program 10 or a system administrator may also set control attributes by creating one or more metadata files 90 associated with a destination or associated with a particular file 70, in the same directory 80. There may be a plurality of separate directories 80,82,84 that are each associated with a respective configuration file 102,104 and each of which has one or more destination-specific metadata files 90,92,94, as explained below.

A monitoring component 110 is provided on the data processing apparatus 200. The monitoring component can be implemented in hardware or in software, but a monitoring component according to the current embodiment is implemented in software. This software-implemented monitoring component 110 runs as a daemon process to monitor one or more directories (or to monitor complete file systems) and to identify any new files within those directories. This daemon process may be run whenever an associated messaging manager is run. The daemon process may be configured with information identifying one or more directories that the monitoring component is required to monitor. In one embodiment, the monitoring component is an event-driven observer program or object that is activated by file creation events, file update events and file renaming events. In another embodiment, the monitoring component periodically polls for changes within a monitored directory.

The monitoring component 110 identifies 310 new and changed files, extracts 320 the file contents and generates 330 a new message that contains the file contents (as the message payload), and passes 340 the new message to the local messaging manager 40. The step of generating a new message is performed in accordance with destination-specific and message-specific metadata files 90,92,94, to set requested properties on the message.

The messaging manager 40 then implements functions for transferring 350 messages to destinations elsewhere in the network, via one or more messages. Successfully transferred files may then be deleted from the sender's directory 80,82,84 (or may initially be moved or renamed, and subsequently deleted) by the monitoring component 1 10. The sender data processing system 200 may optionally log this event.

Following an unsuccessful transfer operation, the failed message may be moved to a non-monitored location for subsequent retry (using conventional techniques). The sender system 200 may optionally log this event.

Because file contents are extracted from the original created files, various ‘mediations’ can be performed on the extracted contents. Mediations are programmed functions of a messaging system that can simplify connecting of systems, services, applications or components that use messaging. A mediation is used to process in-flight messages. The type of processing that may be referred to as a mediation includes:
Modifying or transforming an existing message;
Routing messages to destinations other than, and/or additional to, the explicitly identified destinations; and
Allowing or disallowing a message to be delivered, based on conditional logic within the mediation.

Message destinations may be predefined for a monitored directory when the directory is created, and specified within the directory's configuration file 102,104 or within an associated metadata file 90,92,94. Various messaging properties for target destinations and message properties for individual messages can be predefined within the metadata files, and properties of the communication channel are defined within the configuration files. This allows the originating application program 10 to cause a message to be sent to a desired destination merely by creating a file in a particular monitored directory, or by modifying an existing file, while facilitating provision (if required) of a similar level of control over messaging attributes to the control provided by feature-rich APIs.

As noted above, the configuration files 102,104 define known communication channels for the system. A configuration file may define channel and messaging characteristics for one or more messaging managers. An example configuration file specifies properties of the communications channel as follows:

| Name of property | Description |
|---|---|
| XMSC_CONNECTION_TYPE: 1 | identifies the type of |
| | messaging manager to |
| | which an application |
| | connects |
| XMSC_WMQ_CONNECTION_MODE: 1 | the mode by which an |
| | application connects |
| | to a messaging |
| | manager |
| XMSC_WMQ_HOST_NAME : localhost | the host name or IP |
| | address of the system on |
| | which a messaging |
| | manager resides |
| XMSC_WMQ_PORT: 1414 | the number of the port on |
| | which a messaging |
| | manager listens for |
| | incoming requests |
| XMSC_WMQ_QUEUE_MANAGER: QM1 | the name of the |
| | messaging manager |
| | to connect to |

Such a configuration file can be used to control connection to a messaging manager (QM1), such as one of IBM Corporation's WebSphere MQ messaging manager products, using a client connection over a network. The configuration file supplies the host and port information for the named messaging manager QM1. Various other channel properties may also be defined in the configuration file, such as a channel name, a user identifier and password for authenticating the application when it attempts to connect to a messaging manager, an identifier of a cipher and location of cryptographic keys.

In one embodiment, a file system architecture for use with the present invention comprises one or more monitored directories 100, 101 as root nodes of the file system hierarchy. Directory 100 contains a configuration file 102 defining configuration values for a first communication channel. Directories Q1 and Q2 (shown in FIG. 1 as ‘DIRECTORY_Q1’ 80 and ‘DIRECTORY_Q2’ 82 for clarity) at a first level of the hierarchy under the root node are associated with the channel defined in the configuration file 102, and each have a predefined association with a respective one or more message destinations. Messaging properties associated with the respective destinations are held in metadata files 90,92 within the respective directories 80,82. There may be a number of these file system directories 100, 101 on a single data processing system, each containing one or more monitored directories 80,82,84 corresponding to a different destination (in the case of directories Q1 and Q2) or a different communication channel (in the case of directory T1).

Each monitored directory may be organized within the file system directory tree under a particular root node 100,101 containing a configuration file 102,104, with each root node having one or more underlying named directories 80,82,84 in which message files can be created. The created message files will be sent to destinations associated with the respective named directory via the communication channel that is defined in the configuration file.

Each directory may also include files 90,92,94 containing metadata for a target destination, which may apply to all messages sent from this directory; or may include files containing metadata specifying additional behavioral semantics for only a subset of messages sent from the directory. A metadata file can also be associated with a single message.

Any non-standard properties of a message, such as priority, persistence, a character set for character data, encoding for numeric data, or report options, can be specified within a metadata file 90,92,94; whereas default properties and behavior are provided for any unspecified properties and behavior. For example, a metadata file 90 relating to a particular destination may specify one or more of the following properties:

| Name of property | Description |
|---|---|
| XMSC_DELIVERY_MODE | The delivery mode of messages sent to the |
| | destination |
| XMSC_PRIORITY | The priority of messages sent to the |
| | destination |
| XMSC_TIME_TO_LIVE | The time to live or expiry interval for |
| | messages sent to the destination |
| XMSC_WMQ_CCSID | The identifier (CCSID) of the coded |
| | character set, or code page, that the strings |
| | of character data in the body of a message |
| | will be in when the messaging client |
| | forwards the message to the destination |
| XMSC_WMQ_ENCODING | How numerical data in the body of a |
| | message will be represented when the |
| | messaging client forwards the message to |
| | the destination |

A message metadata file 90 may identify the message group to which a message belongs; the sequence number of the message within a message group; a request for confirmation on arrival and/or confirmation on delivery; and various other properties.

Behavior such as the deleting of successfully transferred files, and procedures for handling error conditions, can be specified within the configuration files or metadata files. The change monitoring component is able to interpret these configuration files and metadata files to achieve desired messaging semantics, such that application programmers and users can have comprehensive non-programmatic access to messaging functions.

In FIG. 1, the sending system 200 includes a publish/subscribe message broker 120, which performs subscription matching for some of the generated messages by reference to a table of subscriptions 130, to enable multicast distribution by the local messaging manager 40. A publish/subscribe message broker 120 may be an integral component of the messaging manager 40. In one embodiment of the invention, the monitoring component 110 (for example, a particular instance or thread of the monitoring component) monitors a file system directory 84 which is reserved for files that will be transferred using publish/subscribe messaging. Files stored in this directory 84 require subscription matching by the message broker 120, to determine interested subscribers. This requirement for subscription matching to identify target destinations is indicated within a metadata file 94 within the directory 84, which metadata file includes a full topic name for use in subscription matching. That is, the monitoring component 110 includes program code for specifying to the messaging manager 40 a target destination (e.g. Q1) which the monitoring component has obtained from a destination-specific metadata file or a message-specific metadata file 90,92; but if the monitored directory 84 includes a metadata file 94 specifying a topic for use in subscription matching then the monitoring component responds by invoking the subscription matching functions of the publish/subscribe broker 120.

In this case, additional predefined properties of the channel or destination may include: an identifier for the message broker 120 (or the name of a local message queue monitored by the broker 120); the name of the topic space that contains the topic that will be used to identify interested subscribers; and a desired multicast setting. These properties may be specified within a configuration file 104 associated with the respective directory 84, or within a metadata file 94 associated with a named destination, message, or set of messages.

According to the present embodiment, as is clear from the above description of an exemplary system implementing the invention, a system user can initiate point-to-point messaging or publish/subscribe messaging by choosing a different directory in which to save a newly created or modified file, and can access advanced messaging semantics by means of the metadata files.

In another embodiment of the invention, a remote target destination may comprise a publish/subscribe broker. The sender system communicates with the broker using point-to-point messaging, including a topic name within the generated messages, and then the broker handles required mediations and routing to interested subscribers. Properties of the destination, connection or message that are required by the remote broker can be specified within configuration file 104 or within respective metadata files.

The name of a monitored directory may indicate the intended destination (for example, directory name ‘Q1’ indicating that a message queue identified as Q1 is the target destination for any new files created in that directory). Metadata associated with the directory may indicate whether the directory name represents a target queue (for point-to-point messaging) or a topic for use in the identification of interested subscribers (when using a publish/subscribe model, see for example ‘T1’ in FIG. 1). Predefined message file names and file attributes may also be used to indicate certain desired messaging behavior.

In an alternative embodiment of the invention, a single monitored directory can be used with a range of file names that indicate the desired messaging model and properties of the communication channel, destination and messages.

Thus, a first set of embodiments of the present invention provide a simple and generic mechanism for users and sender application programs to access both point-to-point messaging functions and publish/subscribe messaging functions. These embodiments can provide the combined benefits of ease of use, simple integration between the point-to-point and publish/subscribe communication models, and great flexibility because of the lack of any limitation to a particular application programming language or messaging manager (see the description below of delegating message creation to an XMS implementation). Basic messaging behaviors can be accessed by simply creating a file within a monitored directory, whereas more advanced messaging options and support for publish/subscribe communications can be achieved using configuration files and metadata files (associated with particular directories and files) and by using message file names and directory names that imply particular destinations or required behaviors. Thus, the present invention can be implemented to provide non-programmatic access to a wide range of different messaging behaviors—from simple to advanced and using different communication models.

In another embodiment of the invention (either as an alternative to or in combination with the above-described predefinition of destinations and metadata), additional messaging semantics and various requirements for the message transfer may be inferred by the monitoring component, or by its associated messaging manager, from additional information specified within a metadata file or specified when an originating application program issues a file create instruction. This information is referred to below as an ‘expression of intent’, since some of the information requires interpretation by the monitoring component. Such interpretation may be required, for example, to dynamically select one or more destinations in response to an ‘expression of intent’ regarding intended destinations. In one embodiment of the invention, the monitoring component 110 or an associated means for generating a message implements a set of optional messaging semantics, and the optional messaging semantics are selectable in accordance with instructions from a file-oriented application program when creating a new file. The monitoring component is adapted to identify selection instructions provided by the file-oriented application program when creating the file, to select the desired messaging semantics.

In one embodiment of the invention, expressions of intent (see above) can be specified in a short-hand notation and the monitoring component is responsive to such short-hand expressions of intent. That is, components of the invention are implemented to respond to a set of predefined expression types that represent common use-cases for message files, such as a requirement to duplicate files to a second destination whenever targeted at a particular first destination. This may be desirable, for example, for logging purposes. In some cases, these ‘expressions of intent’ can help to extend messaging to new application domains. Many existing software components, which write their output to a file, can be usefully and transparently integrated with messaging functions (without modification) using the present invention. A number of example expressions of intent are set out below.
1. A first example short-hand expression of intent uses a keyword and destination names as follows:

Cc: <list of destinations>

For example, an expression “Cc: Q2,Q3” within a metadata file for destination Q1 can be used to instruct the monitoring component to replicate any messages that are being sent to destination Q1 so that they are also sent to destinations Q2 and Q3. It is very common to wish to back up a message to non-volatile storage, and it is also common to implement a highly-available system using redundancy.
2. A second example extends the applicability of the keyword to a configuration file:

Cc: <list of messaging managers>

An expression such as “Cc: QM2, QM3” within a configuration file for the communication channel that defines connectivity to messaging manager QM1 will result in replica messages being sent to multiple messaging managers. The use cases mentioned above for replication to destinations such as Q2 and Q3 apply equally to replication to messaging managers. However, such an expression assumes destination Q1 to be defined on all messaging managers (QM1, QM2 and QM3) if this expression is to result in effective replication, when a message file is put within the relevant directory for destination Q1 underneath the root node that is associated with messaging manager QM1.
3. A third example is based on destination names. A destination name format such as “Q1_Q2_Q3” may be interpreted by the monitoring component as an instruction to send messages to three destinations (Q1, Q2 and Q3) when a message file is placed within a particular directory that is associated with these destinations. Application program 10 may dynamically create a directory named in the above manner to exploit this ‘expression of intent’. The conventional approach of using an API-based sender application would require Q1, Q2 and Q3 names to be known at compile-time of the sender application or would need to be provided as an argument or configuration information for the sender application. Neither of the known approaches offers the flexibility provided by the illustrative example using a destination name format such as “Q1_Q2_Q3”. This expression format, and in particular the use of underscores to delimit destination names, is intended to be an illustrative example only.
4. As a fourth example expression, other keywords may be used:

Alternation: <list of destinations>

An expression such as “Alternation: Q2, Q3” within the metadata file for destination Q1 will imply that the monitoring component should alternate message sends to Q1, Q2 and Q3 destinations in a round-robin fashion (for example). This facilitates balancing of workload by routing each successive message to a different one of the named destinations, each of which is being serviced by an independent process.
5. A further example expression is:

Log: <list of destinations>

An expression such as “Log: Q2” in the metadata file for destination Q1 implies that the monitoring component should send a message based on the newly created file to destination Q1, and at the same time send a “log message” to destination Q2. The log message can contain metadata about the message sent to Q1 and/or the contents (partial or complete) of the message sent to Q1.

In the present embodiment, each of the predefined expressions of intent using keywords and predefined short-form notation require program code for interpreting those expressions to be available within the monitoring component. While the above example expressions relate to messaging semantics associated with a message sending system, it should be noted that keywords may define semantics only for a message send operation, only for a message receive operation, or both.

In one embodiment, the file system paradigm may be provided as an abstraction on top of a traditional programmatic paradigm, with the monitoring component delegating to an API of a messaging manager (ideally an API that can provide generic support for two or more alternative messaging managers). In a first example, the monitoring component delegates to a message service client program that implements the IBM Message Service API (known informally as XMS). The message service client program packages 330 the extracted file contents into a message format. That is, the monitoring component at the sender end reads 320 the contents of a file and an associated component translates 330 the file contents into a message that is then ‘Put’ to a queue or published 340,350 (for point-to-point or publish/subscribe messaging).

The IBM Message Service API (XMS) is an API that is available in a number of programming languages, implemented by a collection of messaging clients, to provide JMS features on behalf of C, C++ and C# programs. The currently available XMS implementations are formally known as the IBM Message Service Clients for C/C++ and .NET and are described in IBM Document No. SC34-6778-02 “Message Service Clients for C/C++ and .NET”, IBM Corporation, February 2007 (and are provided as part of IBM Corporation's WebSphere Business Integration family of products). By using the monitoring component in combination with an XMS implementation, one embodiment of the present invention provides simple access to messaging managers that provide both point-to-point and publish/subscribe messaging. XMS (and JMS) reduces the complexity of publish/subscribe messaging by hiding the way the underlying messaging managers generate publications or register subscriptions, such that application developers can avoid having to learn the implementation details of different messaging managers. The XMS API provides a consistent programming model across multiple languages by offering a common set of high-level classes to perform messaging operations. XMS also offers a choice of synchronous and asynchronous approaches to receipt of messages. To receive a message synchronously, an application calls a receive() method, which returns if a message is available. To receive messages asynchronously, an application registers a MessageListener object (or callback function in C) with a message consumer. When a MessageListener object has been registered, XMS starts a thread to listen for new messages. When a message needs to be delivered to the message consumer, a method is called on the background thread of the MessageListener object. The present invention can be implemented so as to exploit these benefits while also exploiting the monitoring component's ability to simplify application program operations (and hence to simplify application development).

According to a second aspect of the invention, and as shown in FIGS. 1 and 3, a message receiver data processing system 210 is provided which facilitates a file-oriented application program gaining access to the data contents of a received message. A file creator component 140 is associated with a receiving messaging manager component 50 within a network-connected data processing apparatus. The file creator component 140 either proactively polls for new messages received via the underlying messaging manager 50 or, as in the present embodiment, is event-driven and is invoked 400 by the receiving messaging manager 50. When a new message is received 400, the file creator component 140 on the receiving system 210 unpacks 410 the message contents from the message header and passes its output to the file creator component which creates 420 a file containing the message contents and saves the created file in a target directory 150. A receiver application program 20 can then retrieve the file from the target directory 150, for example by opening 430 the file using conventional file-oriented access techniques. An additional metadata file may be saved in directory 150 association with the message contents file, if message header information is likely to be needed by the receiving application program. Thus, an embodiment of this second aspect of the present invention provides a file creator component as a new messaging client program which interfaces between the file system and with the receiving messaging manager, to enable application programs running on the receiving system to access messages using conventional file system commands.

In one embodiment of this second aspect of the invention, the file system paradigm may be provided as an abstraction on top of a traditional programmatic paradigm, with the file creator component delegating to an API of a messaging system. As stated above in relation to the message sending system, this API should ideally be one that can provide generic support for two or more alternative messaging systems—such as the XMS API. In the present embodiment, the file creator component 140 delegates to an XMS-implementing message service client program to receive messages from a messaging manager 50 and to unpack the message to extract 410 the message contents. The file creator component 140 then receives the message contents from the XMS implementation. The file creator 140 creates one or more files containing the message contents, which it saves within one or more directories representing destinations from which messages have been received. The file creator component may implement polling techniques and delegate to a synchronous message receiver implementation of XMS, or the file creator may implement event-based techniques and delegate to an asynchronous message receiver implementation of XMS.

As noted earlier, this second aspect of the invention can be implemented at a message receiver data processing system, with or without an implementation of the first aspect. Similarly, the first aspect of the invention may be implemented with or without the second aspect. Thus, embodiments of the invention provide methods, computer programs and data processing systems which can simplify access to messaging functions for message originating systems, message receiving systems or both, by providing new file-system-aware sender and/or receiver messaging client programs that interface between a local messaging manager component and a local file system.

Typical persons skilled in the relevant art will recognize that various equivalents, modifications and extensions to the above-described embodiments may be made within the scope of the present invention as described and claimed herein, and the above-described embodiments should be interpreted as illustrative of the invention rather than limiting the scope of the invention. For example, the embodiments described above include embodiments monitoring file updates within monitored directories in which a directory name can be used to imply the intended destination for any files placed in the directory, or the topic to be used in a topic-based subscription matching process performed by a publish/subscribe matching engine. In another embodiment, content-based publish/subscribe communications are implemented. In such an embodiment, a monitoring component is responsible for identifying new files placed within a particular directory or set of directories, extracting the file contents and passing the file contents to a content-based publish/subscribe engine for comparison with stored subscriptions. A message including the file contents (or derived by the matching engine in response to matching the file contents with one or more stored subscriptions) is then sent to the respective subscribers.

As will be appreciated by one skilled in the art, embodiments of the invention may be embodied as a system, method or computer program product. Accordingly, embodiments of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of embodiments of the invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A data processing system comprising:
at least one data processing unit;
at least one data storage unit;
a messaging manager for handling delivery of messages to and from messaging managers of other data processing systems;
a monitoring component adapted to identify file updates within a monitored data storage area of the at least one data storage unit, and to extract file contents from the identified updated files;
means for generating a message that includes the extracted file contents; and
means for passing the generated message to the messaging manager for delivery to a target data processing system.

2. The system of claim 1, wherein the monitored data storage area comprises a file system directory and the monitoring component is configured to identify addition of a new file within the monitored file system directory.

3. The system of claim 2, wherein the monitoring component is configured to also identify modification of an existing file within the monitored file system directory.

4. The system of claim 1, wherein the monitoring component is event-driven and is invoked by creation of new files within the monitored data storage area.

5. The system of claim 1, wherein the monitoring component is adapted to periodically poll the monitored data storage area for file updates.

6. The system of claim 1, further comprising:
means for associating a configuration file with the monitored data storage area, the configuration file defining properties of a communications channel;
means for examining the configuration file associated with the monitored data storage area; and
means for establishing a communication channel between the messaging manager and a second messaging manager located on a second data processing system, the communication channel having the defined properties.

7. The system of claim 1, further comprising:
means for associating a metadata file with the monitored data storage area, which metadata file defines message properties;
wherein the means for generating a message comprises:
means for examining the metadata file associated with the monitored data storage area; and
means for generating a message that is consistent with the defined message properties.

8. The system of claim 7, wherein the means for examining a metadata file comprises means for responding to a topic name within the metadata file to initiate topic based subscription matching to identify interested subscribers for the generated message.

9. The system of claim 1, further comprising:
at least one file-oriented application program and an operating system program installed on the data processing system, wherein the operating system program provides file-oriented functions including a create file function that enables the at least one file oriented application program to create files within the monitored data storage area.

10. The system of claim 9, wherein the means for generating a message implements a set of optional messaging semantics, the optional messaging semantics being selectable in accordance with instructions from the file-oriented application program, and wherein the monitoring component is adapted to identify selection instructions provided by the file-oriented application program when creating a file to select desired messaging semantics.

11. The system of claim 1, further comprising means for performing a message mediation that involves analyzing the contents of the generated message.

12. The system of claim 11, wherein the message mediation comprises filtering messages based on the message contents.

13. The system of claim 1, further comprising:
a file creator component adapted to receive one or more messages via the messaging manager, to create one or more files holding the contents of the one or more received messages, and to save the created files within a file system directory of the at least one data storage unit.

14. A method for generating messages for transfer within a messaging network, the method being performed within a data processing system that comprises at least one data processing unit, at least one data storage unit and a messaging manager, the method comprising:
monitoring a data storage area within the at least one data storage unit to identify file updates within the monitored data storage area;
extracting file contents from the identified files;
generating at least one message that includes the extracted file contents; and
passing the generated at least one message to the messaging manager for transfer within the messaging network.

15. The method of claim 14, further comprising:
responding to creation of a new file within the monitored data storage area by examining a configuration file associated with the monitored data storage area within which the new file was created;
identifying required communication channel properties specified within the configuration file; and
establishing a communication channel connection to a messaging manager, the channel having the specified communication channel properties.

16. The method of claim 15, wherein the step of generating at least one message generates a message that is consistent with one or more message properties defined by a metadata file associated with the created file.

17. The method of claim 16, further comprising:
identifying a topic name within the metadata file; and
in response to said identifying, initiating topic-based subscription matching to identify interested subscribers for the generated message.

18. The method of claim 14, further comprising:
examining a configuration file associated with the monitored data storage area, which configuration file defines properties of a communications channel; and
passing the generated message to the messaging manager via the defined communication channel.

19. The method of claim 14, further comprising:
receiving one or more messages via the messaging manager;
creating one or more files holding the contents of the one or more received messages; and
saving the created one or more files within a file system directory of the at least one data storage unit.

20. A computer program product for generating messages for transfer within a messaging network and for controlling operations on a data processing system that comprises at least one data processing unit, at least one data storage unit and a messaging manager, the computer program product comprising at least one computer-readable storage medium having computer-readable program code stored therein, the computer-readable program code comprising:
computer-usable program code for monitoring a data storage area within the at least one data storage unit to identify file updates within the monitored data storage area;
computer-usable program code for extracting file contents from the identified files;
computer-usable program code for generating at least one message that includes the extracted file contents; and
computer-usable program code for passing the generated at least one message to the messaging manager for transfer within the messaging network.

21. The computer program product of claim 20, further comprising:
computer-usable program code for responding to creation of a new file within the monitored data storage area by examining a configuration file associated with the monitored data storage area within which the new file was created;
computer-usable program code for identifying required communication channel properties specified within the configuration file; and
computer-usable program code for establishing a communication channel connection to a messaging manager, the channel having the specified communication channel properties.

22. The computer program product of claim 21, wherein the computer-usable program code for generating at least one message generates a message that is consistent with one or more message properties defined by a metadata file associated with the created file.

23. The computer program product of claim 22, further comprising:
computer-usable program code for identifying a topic name within the metadata file; and
computer-usable program code for, in response to said identifying, initiating topic-based subscription matching to identify interested subscribers for the generated message.

24. The computer program product of claim 20, further comprising:
computer-usable program code for examining a configuration file associated with the monitored data storage area, which configuration file defines properties of a communications channel; and
computer-usable program code for passing the generated message to the messaging manager via the defined communication channel.

25. The computer program product of claim 20, further comprising:
computer-usable program code for receiving one or more messages via the messaging manager;
computer-usable program code for creating one or more files holding the contents of the one or more received messages; and
computer-usable program code for saving the created one or more files within a file system directory of the at least one data storage unit.
